(19) United States
(12) Patent Application Publication
(10) Pub. No.: US 2010/0289797 A1
(43) Pub. Date: Nov. 18, 2010

(54) POSITION AND ORIENTATION ESTIMATION APPARATUS AND METHOD

(75) Inventors: Keisuke Tateno, Kawasaki-shi (JP); Daisuke Kotake, Yokohama-shi (JP); Shinji Uchiyama, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/778,385

(22) Filed: May 12, 2010

(30) Foreign Application Priority Data
May 18, 2009 (JP) 2009-120391

(51) Int. Cl. G06T 15/00

(52) U.S. Cl. 345/419

(57) ABSTRACT

A position and orientation estimation apparatus detects correspondence between a real image obtained by an imaging apparatus by imaging a target object to be observed and a rendered image. The rendered image is generated by projecting a three dimensional model onto an image plane based on three dimensional model data expressing the shape and surface information of the target object, and position and orientation information of the imaging apparatus. The position and orientation estimation apparatus then calculates a relative position and orientation of the imaging apparatus and the target object to be observed based on the correspondence. Then, the surface information of the three dimensional model data is updated by associating image information of the target object to be observed in the real image with the surface information of the three dimensional model data, based on the calculated positions and orientations.

### BACKGROUND OF THE INVENTION

1. Field of the Invention

The present invention relates to position and orientation measurement technology to measure relative positions and orientations of an imaging apparatus and a target object to be observed, with use of three dimensional model data expressing the shape of the target object to be observed and a sensed image of the target object to be observed that has been imaged by the imaging apparatus.

2. Description of the Related Art

Technology has been proposed for using an imaging apparatus, such as a camera that images a real space, to measure relative positions and orientations of a target object to be observed and the imaging apparatus that images the target object to be observed. Such position and orientation measurement technology is very useful in mixed reality systems that display a fusion of a real space and a virtual space, and in the measurement of the position and orientation of a robot. In this position and orientation measurement technology, if the target object to be observed is known in advance, estimating the position and orientation of the object by comparing and cross-checking information on the object and an actual image is problematic.

As a countermeasure for this, a technique for estimating the position and orientation of an object relative to a monitoring camera by creating a CG rendering of a three dimensional model expressing the shape of the object and surface information (for example, color and texture) is disclosed in “G. Reitmayr and T. W. Drummond, ‘Going out: robust model-based tracking for outdoor augmented reality,’ Proc. The 5th IEEE/ACM International Symposium on Mixed and Augmented Reality (ISMAR06), pp. 109-118, 2006” (hereinafter, called “Document 1”). The basic approach of this technique is a method of correcting and optimizing the position and orientation of the camera so that a rendered image obtained by creating a CG rendering of the three dimensional model and a real image obtained by imaging the actual object become aligned.

Specifically, first in step (1), a CG rendering of three dimensional model data is created based on the position and orientation of the camera in a previous frame and intrinsic parameters of the camera that have been calibrated in advance. This obtains an image in which surface information (luminance values of surfaces) in the three dimensional model data is projected onto an image plane. This image is referred to as the rendered image. In step (2), edges are detected in the rendered image obtained as a result. Here, areas in the image where the luminance changes discontinuously are referred to as edges. In step (3), edges are detected in a real image such as a sensed image, in the vicinity of positions where edges were detected in the rendered image. According to this processing, a search is performed to find out which edges in the rendered image correspond to which edges in the real image. In step (4), if a plurality of detected edges in the real image correspond to an edge in the rendered image in the correspondence search performed in the previous step, one of the corresponding edges is selected with use of degrees of similarity of the edges. The degrees of similarity of the edges are obtained by comparing, using normalized cross-correlation, luminance distributions in the periphery of the edges in both images. According to this processing, the edge having the closest edge appearance (here, the luminance distribution in the edge periphery) among the edges in the real image detected as corresponding candidates is selected as the corresponding edge. In step (5), a correction value for the position and orientation of the imaging apparatus is obtained so as to minimize the distances within the images between the edges detected in the rendered image and the corresponding edges detected in the real image, and the position and orientation of the imaging apparatus is updated. The ultimate position and orientation of the imaging apparatus is obtained by repeating this processing until sums of the above-described distances converge.

In the above-described position and orientation estimation method based on a three dimensional model, positions and orientations are estimated based on associations between edges in a rendered image and edges in a real image, and therefore the accuracy of the edge associations has a large influence on the precision of the position and orientation estimation. In the above-described technique, edges are associated by comparing luminance distributions in the periphery of edges detected in both images, and selecting edges that are most similar between the images. However, if surface information in the three dimensional model data used in the position and orientation estimation greatly differs from the target object imaged in the real image, it is difficult to correctly associate edges even when luminance distributions extracted from the rendered image and the real image are compared. In view of this, in the technique described above, three dimensional model data that is close to the appearance of the target object imaged in the real image is generated by acquiring a texture in the three dimensional model in advance from the real image. Also, in the technique disclosed in “T. Moritani, S. Hiura, and K. Sato, ‘Object tracking by comparing multiple viewpoint images with CG images,’ Journal of IEICE, Vol. J88-D-II, No. 5, pp. 876-885 (March 2005)” (hereinafter, called “Document 2”), a rendered image whose appearance is close to a target object imaged in a real image is generated by acquiring the light source environment in a real environment in advance, setting a light source that conforms with the actual light source environment, and rendering a three dimensional model including a texture.

Also, as a different countermeasure from the countermeasure using surface information in three dimensional model data, a technique for sequentially acquiring and updating luminance distributions in edge peripheries based on real images in past frames is disclosed in “H. Wuest, F. Vial, and D. Stricker, ‘Adaptive line tracking with multiple hypotheses for augmented reality,’ Proc. The Fourth Int'l Symp. on Mixed and Augmented Reality (ISMAR05), pp. 62-69, 2005” (hereinafter, called “Document 3”. In this technique, positions and orientations are calculated by directly associating edges in a three dimensional model projected onto an image plane and edges in a real image, without rendering three dimensional model data. Here, edges are associated with use of luminance distributions acquired from the real image of a previous frame in which associations between edges in the three dimensional model and edges in the real image have already been obtained. The luminance distributions of edges in the three dimensional model are acquired based on the luminance distributions of corresponding edges in the real image of the previous frame, then held, and used in association with edges in the real image of the current frame. This enables highly precise association of edges with use of luminance distributions that are in conformity with the appearance of the target object imaged in the real image.

In the technique disclosed in Document 1, consideration is given to the light source environment and the surface color and pattern of an object imaged in a real image in advance when rendering three dimensional model data so as to obtain an appearance similar to that of a target object to be observed in a real environment. Then, a position and orientation at which the rendered image and the real image are aligned is estimated. This enables stably estimating a position and orientation of the target object as long as the appearance of the target object imaged in the real image is similar to the three dimensional model data that has been created.

However, in the exemplary case where the position and orientation of an object approaching on a belt conveyer in an inside working space as shown in FIG. 2 is to be estimated, the appearance of the object dynamically changes greatly depending on the relative positional relationship between the illumination and the object. For this reason, even if three dimensional model data that reproduces the appearance of the object under a constant illumination environment is created, misalignment occurs between real images and rendered images due to a change in the light source that accompanies the movement, and thus the precision of the position and orientation estimation decreases. Also, the same issue arises in scenes that are influenced by the movement of the sun during the day and changes in the weather, such as outdoor scenes and scenes that include illumination by outdoor light, as well as scenes in which the light source in the environment changes, such as scenes in which the light in a room is turned on/off and scenes in which an object is placed close to the target object. As shown in these examples, there is the issue that the position and orientation estimation technique described above is poor at dealing with situations in which the appearance of the target object changes due to a change in the light source.

To address this, in the method disclosed in Document 2, a rendered image of three dimensional model data is generated by performing CG rendering based on light source information that is known in advance. In an environment where the light source is known in advance, it is therefore possible to deal with a relative positional change in the light source environment. However, there is the issue that it is impossible to deal with cases where the actual position of the light source differs from the set position, such as a case where the light source moves relative to the imaging apparatus as the imaging apparatus moves. Also, the same issue as in the technique disclosed in Document 1 arises if the position of the light source is unknown.

To address these issues, in the technique disclosed in Document 3, luminance distributions of a target object that have been acquired from the real image of a past frame are held and updated in a three dimensional model as one dimensional vectors on an image plane, and are used in association between the three dimensional model and a real image. Accordingly, with this technique, positions and orientations can be estimated without any problems even if a change in the light source of the target object has occurred. However, even at the same point in the three dimensional model, the luminance distribution of the target object to be observed in the real image greatly changes depending on the direction from which the target object is observed. For this reason, if the orientation of the target object has greatly changed between frames, there will be a large difference between the luminance distribution held as one dimensional vectors on the image plane in the three dimensional model and the luminance distribution of the target object to be observed that is imaged in the real image. Therefore the issue arises that accurately associating edges is difficult.

As described above, there are the issues that some conventionally proposed techniques cannot deal with cases where a change in the light source of a target object has occurred, and conventional techniques that can deal with a change in the light source cannot inherently deal with a change in the appearance of a target object that occurs due to a large change in the position and orientation of the target object.

### SUMMARY OF THE INVENTION

The present invention has been achieved in light of the above issues, and according to a preferred embodiment thereof, there is provided a position and orientation estimation apparatus and method that enable the realization of stable position and orientation estimation even in the case where a change in the light source has occurred in a real environment and the case where the appearance of a target object has changed due to a change in the orientation of the target object.

According to one aspect of the present invention, there is provided a position and orientation estimation apparatus comprising:

an acquisition unit configured to acquire a real image obtained by an imaging apparatus by imaging a target object to be observed;

a holding unit configured to hold three dimensional model data expressing a shape and surface information of the target object;

a rendering unit configured to generate a rendered image by projecting a three dimensional model onto an image plane based on the three dimensional model data and position and orientation information of the imaging apparatus;

a calculation unit configured to detect correspondence between the rendered image generated by the rendering unit and an image of the target object in the real image, and calculate a relative position and orientation of the imaging apparatus and the target object based on the correspondence; and

an updating unit configured to update the surface information of the three dimensional model data held in the holding unit by, based on the positions and orientations calculated by the calculation unit, associating the image of the target object in the real image with the surface information of the three dimensional model data.

Further features of the present invention will become apparent from the following description of exemplary embodiments with reference to the attached drawings.

### BRIEF DESCRIPTION OF THE DRAWINGS

FIG. 1 is a diagram showing a configuration of a position and orientation estimation apparatus according to Embodiment 1.

FIG. 2 is a diagram showing a change in a light source of a target object that accompanies a change in the relative positions and orientations of the target object and the light source environment.

FIG. 3 is a flowchart showing a processing procedure of a position and orientation estimation method that employs three dimensional model data according to Embodiment 1.

FIG. 4 is a flowchart showing a detailed processing procedure of model feature extraction for position and orientation estimation according to Embodiment 1.

FIG. 5 is a flowchart showing a detailed processing procedure performed in the association of rendered image features and real image features according to Embodiment 1.

FIG. 6 is a flowchart showing a detailed processing procedure performed in the updating of surface information in three dimensional model data, based on a real image, according to Embodiment 1.

FIG. 7 is a diagram showing a configuration of a position and orientation estimation apparatus 2 according to Embodiment 2.

FIG. 8 is a flowchart showing a processing procedure of a position and orientation estimation method that employs three dimensional model data according to Embodiment 2.

### DESCRIPTION OF THE EMBODIMENTS

Below is a detailed description of preferred embodiments of the present invention with reference to the attached drawings.

### Embodiment 1

### Appearance Updating in Position and Orientation Estimation that Employs Edges

In the present embodiment, a case is described in which an image processing apparatus and a method for the same of the present invention have been applied to a technique for performing position and orientation estimation based on associations between edges extracted from the rendered result of a three dimensional model and a real image.

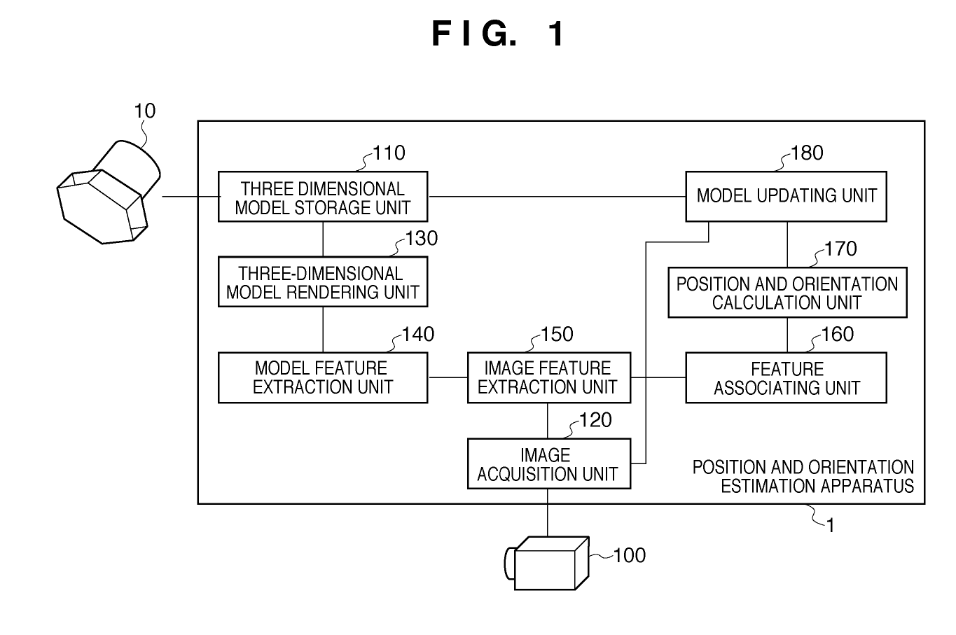

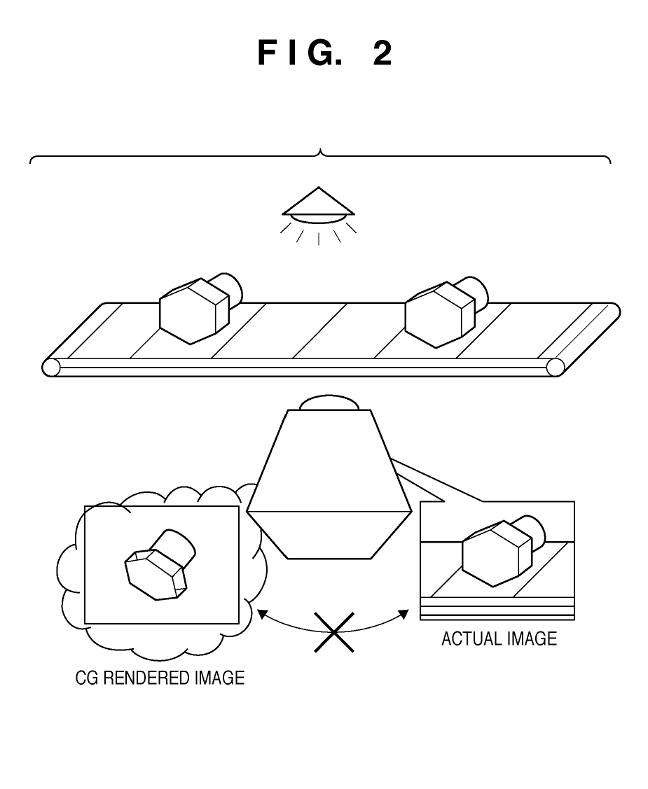

FIG. 1 shows a configuration of a position and orientation estimation apparatus 1 that performs position and orientation estimation with use of three dimensional model data 10 that expresses the shape of a target object to be observed. In the position and orientation estimation apparatus 1, a three-dimensional model storage unit 110 stores the three dimensional model data 10. An image acquisition unit 120 acquires a sensed image from an imaging apparatus 100 as a real image. A three-dimensional model rendering unit 130 generates a rendered image by projecting the three dimensional model data 10 stored in the three-dimensional model storage unit 110 onto an image plane and then performing rendering. A model feature extraction unit 140 extracts features (for example, edge features and point features) from the rendered image rendered by the three-dimensional model rendering unit 130, based on, for example, luminance values and/or colors in the rendered image. An image feature extraction unit 150 extracts features (for example, edge features and point features) from an image of a target object to be observed in the real image acquired by the image acquisition unit 120, based on, for example, luminance values and/or colors in the image. A feature associating unit 160 associates the features extracted by the model feature extraction unit 140 and the features extracted by the image feature extraction unit 150. A position and orientation calculation unit 170 calculates the position and orientation of the imaging apparatus 100 based on feature areas associated by the feature associating unit 160. A model updating unit 180 associates the three dimensional model data and the real image based on the position and orientation calculated by the position and orientation calculation unit 170, and updates surface information (for example, a texture) included in the three dimensional model data 10. The imaging apparatus 100 is connected to the image acquisition unit 120.

According to the above configuration, the position and orientation estimation apparatus 1 measures the position and orientation of a target object to be observed that is imaged in a real image, based on the three dimensional model data 10 that is stored in the three-dimensional model storage unit 110 and expresses the shape of the target object to be observed. Note that in the present embodiment, there is the assumption that the applicability of the position and orientation estimation apparatus 1 is conditional upon the fact that the three dimensional model data 10 stored in the three-dimensional model storage unit 110 conforms with the shape of the target object to be observed that is actually imaged.

Next is a detailed description of the units configuring the position and orientation estimation apparatus 1. The three-dimensional model storage unit 110 stores the three dimensional model data 10. The three dimensional model data 10 is a model that expresses three-dimensional geometric information (vertex coordinates and plane information) and surface information (colors and textures) of a target object to be observed, and is a reference used in position and orientation calculation. The three dimensional model data 10 may be in any format as long as geometric information expressing the shape of a target object can be held, and furthermore surface information corresponding to the geometric information of the target object can be held. For example, the geometric shape may be expressed by a mesh model configured by vertices and planes, and the surface information may be expressed by applying a texture image to the mesh model using UV mapping. Alternatively, the geometric shape may be expressed by a NURBS curved plane, and the surface information may be expressed by applying a texture image to the NURBS curved plane using sphere mapping. In the present embodiment, the three dimensional model data 10 is a CAD model including information expressing vertex information, information expressing planes configured by connecting the vertices, and information expressing texture image coordinates corresponding to a texture image and the vertex information.

The image acquisition unit 120 inputs a sensed image that has been imaged by the imaging apparatus 100 to the position and orientation estimation apparatus 1 as a real image. The image acquisition unit 120 is realized by an analog video capture board if the output of the imaging apparatus is analog output such as an NTSC signal. If the output of the imaging apparatus is digital output such as an IEEE 1394 signal, the image acquisition unit 120 is realized by, for example, an IEEE 1394 interface board. Also, the digital data of still images or moving images stored in a storage device (not shown) in advance may be read out. Accordingly, the image acquired by the image acquisition unit 120 is hereinafter also referred to as the real image.

The three-dimensional model rendering unit 130 renders the three dimensional model data 10 stored in the three-dimensional model storage unit 110. The graphics library used in the rendering performed by the three-dimensional model rendering unit 130 may be a widely used graphics library such as OpenGL or DirectX, or may be an independently developed graphics library. Specifically, any system may be used as long as the model format stored in the three-dimensional model storage unit 110 can be projected onto an image plane. In the present embodiment, OpenGL is used as the graphics library.

The model feature extraction unit 140 extracts features from the rendered image generated by the three-dimensional model rendering unit 130 for applying the three dimensional model to the sensed image (real image). In the present embodiment, the model feature extraction unit 140 extracts edge information from the rendered image that has been rendered by the three-dimensional model rendering unit 130 based on the three dimensional model and the position and orientation of the imaging apparatus 100. A technique for extracting features from the model (rendered image) is described later.

The image feature extraction unit 150 detects, in the real image acquired by the image acquisition unit 120, image features to be used in the calculation of the position and orientation of the imaging apparatus 100. In the present embodiment, the image feature extraction unit 150 detects edges in the sensed image. A method for detecting edges is described later.

The feature associating unit 160 associates the features extracted by the model feature extraction unit 140 and the features extracted by the image feature extraction unit 150, with use of luminance distributions extracted from the rendered image and real image. A method for associating features is described later.

Based on feature association information obtained by the feature associating unit 160, the position and orientation calculation unit 170 calculates the position and orientation of the imaging apparatus 100 in a coordinate system that is based on the three dimensional model data 10.

The model updating unit 180 acquires and updates the surface information included in the three dimensional model data 10 based on position and orientation information calculated by the position and orientation calculation unit 170 and the real image acquired by the image acquisition unit 120. A method for updating three dimensional model data is described later.

Note that the position and orientation estimation method that employs the three dimensional model data 10 is not limited to the technique used by the position and orientation estimation apparatus 1 according to the present embodiment, and may be any method as long as position and orientation estimation is performed by applying a three dimensional model and a real image together. For example, there is no detriment to the essence of the present invention even if the technique disclosed in Document 2 is used.

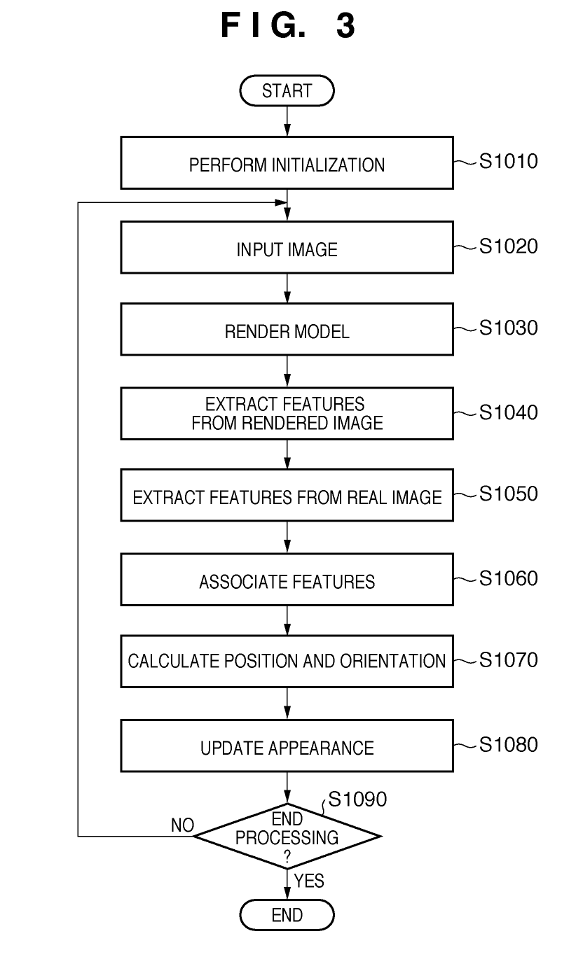

Next is a description of a processing procedure of the position and orientation estimation method according to the present embodiment. FIG. 3 is a flowchart showing the processing procedure of the position and orientation estimation method according to the present embodiment.

First, initialization is performed in step S1010. Here, settings regarding relative approximate positions and orientations of the imaging apparatus 100 and a target object to be observed in a reference coordinate system, and surface information in three dimensional model data are initialized.

The position and orientation measurement method according to the present embodiment is a method in which the approximate position and orientation of the imaging apparatus 100 is successively updated with use of edge information of the target object to be observed that is imaged in a sensed image. For this reason, an approximate position and orientation of the imaging apparatus 100 need to be given as an initial position and initial orientation in advance, before the position and orientation measurement is started. In view of this, for example, a predetermined position and orientation are set, and initialization is performed by moving the imaging apparatus 100 so as to be in the predetermined position and orientation. Also, a configuration is possible in which an artificial index that is recognizable by merely being detected in an image is disposed, the position and orientation of the imaging apparatus are obtained based on the association between image coordinates of vertices of the index and three dimensional positions in the reference coordinate system, and the obtained position and orientation are used as the approximate position and orientation. Furthermore, a configuration is possible in which a highly identifiable natural feature point is detected in advance and the three dimensional position thereof is obtained, that feature point is detected in the image at the time of initialization, and the position and orientation of the imaging apparatus is obtained based on the association between the image coordinates of that feature point and the three dimensional position. In another possible configuration, the position and orientation of the imaging apparatus are obtained based on a comparison between edges extracted from geometric information of a three dimensional model and edges in an image, as disclosed in “H. Wuest, F. Wientapper, D. Stricker, W. G. Kropatsch, ‘Adaptable model-based tracking using analysis-by-synthesis techniques,’ Computer Analysis of Images and Patterns, 12th International Conference, CAIP2007, pp. 20-27, 2007” (hereinafter, called “Document 4”). In yet another possible configuration, the position and orientation of the imaging apparatus are measured using a magnetic, optical, ultrasonic, or other type of six degrees of freedom position and orientation sensor, and the measured position and orientation are used as the approximate position and orientation. Also, initialization may be performed using a combination of a position and orientation of the imaging apparatus 100 that have been measured with use of image information such as an artificial index or a natural feature point, and the six degrees of freedom position and orientation sensor described above, a three degrees of freedom orientation sensor, or a three degrees of freedom position sensor.

Also, in the position and orientation measurement method according to the present embodiment, position and orientation estimation is performed with use of the rendered results of CG rendering performed based on surface information and a shape in three dimensional model data. For this reason, surface information is assumed to have been set in the three dimensional model data 10. However, there are cases in which three dimensional model data 10 in which surface information has not been set is used, and cases in which inappropriate information has been set as the surface information in the three dimensional model data 10. In view of this, in such cases, the surface information of the three dimensional model is initialized with use of a real image in which a position and orientation have been obtained through the above-described position and coordinate initialization processing. Specifically, a correspondence relationship between image information of the object to be observed that is imaged in the real image and the surface information of the three dimensional model is calculated with use of the position and orientation obtained through the position and orientation initialization processing. Then, the surface information of the three dimensional model is initialized by reflecting the image information of the real image in the surface information of the three dimensional model based on the obtained correspondence relationship. Specifically, since surface information of a three dimensional model is dynamically acquired, surface information that is in compliance with a target object in a real environment is reflected even if erroneous information has been stored in the surface information of the three dimensional model in advance. Also, even if a three dimensional model does not originally include surface information, acquiring target object image information from a real image enables performing position and orientation estimation based on surface information of a three dimensional model.

In step S1020, the image acquisition unit 120 inputs an image that has been imaged by the imaging apparatus 100 to the position and orientation estimation apparatus 1.

Next, in step S1030 the three-dimensional model rendering unit 130 performs CG rendering with use of the three dimensional model data 10, thus obtaining a rendered image for comparison with the real image. First, CG rendering is performed with use of the three dimensional model data 10 stored in the three-dimensional model storage unit 110 based on the approximate position and orientation of the target object to be observed that was obtained in step S1010. In the present embodiment, internal parameters of a projection matrix used in the rendering are set so as to match the internal parameters of the camera that is actually used, that is to say, the internal parameters of the imaging apparatus 100 that have been measured in advance. CG rendering refers to projecting the three dimensional model data 10 stored in the three-dimensional model storage unit 110 onto an image plane based on the position and orientation of the point of view set in step S1010. In order to perform CG rendering, it is necessary set a position and orientation, as well as set the internal parameters of the projection matrix (focal length, principal point position, and the like). In the present embodiment, the internal parameters of the imaging apparatus 100 (camera) are measured in advance, and then the internal parameters of the projection matrix are set so as to match the camera that is actually used. Also, the calculation cost of the rendering processing is reduced by setting a maximum value and a minimum value of the distance from the point of view to the model, and not performing model rendering outside that range. Such processing is called clipping, and is commonly performed. A color buffer and a depth buffer are calculated through the CG rendering of the three dimensional model data 10. Here, the color buffer stores luminance values that are in accordance with the surface information (texture image) of the three dimensional model data 10 projected onto the image plane. Also, the depth buffer stores depth values from the image plane to the three dimensional model data. Hereinafter, the color buffer is called the rendered image of the three dimensional model data 10. When the rendering of the three dimensional model data has ended, the procedure proceeds to step S1040.

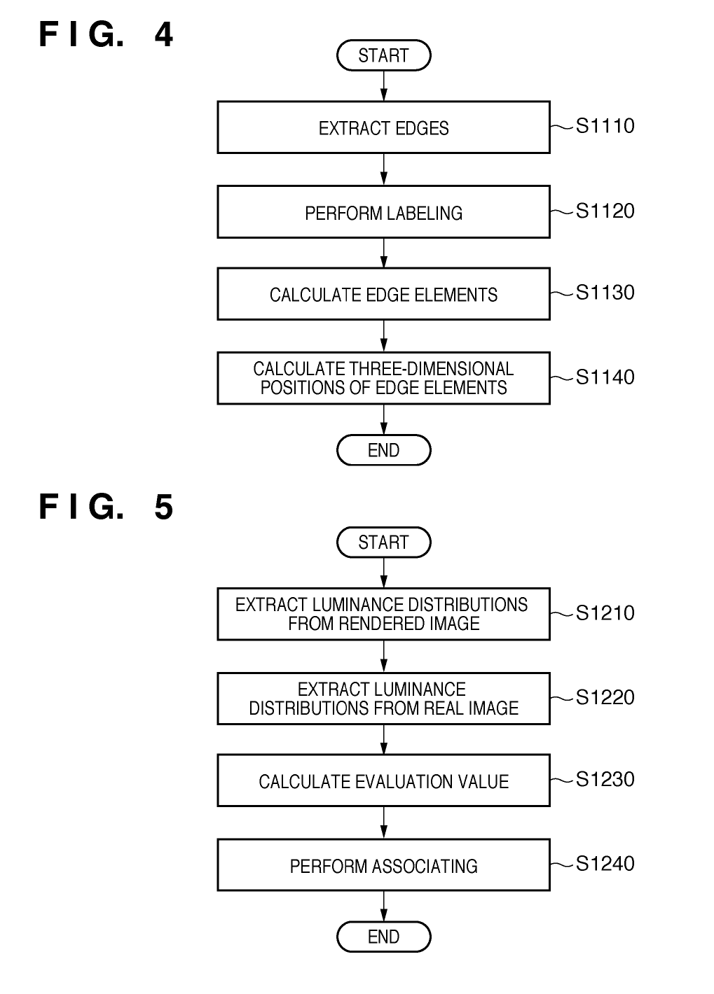

Next, in step S1040, the model feature extraction unit 140 extracts, from the rendered image generated in step S1030, features (in the present embodiment, edge features) for association with the real image. FIG. 4 is a flowchart showing a detailed processing procedure of a method for detecting edge features in a rendered image according to the present embodiment.

First, in step S1110 edge detection is performed on the rendered image generated by the CG rendering performed in step S1030. Performing edge detection on the rendered image enables obtaining areas where the luminance changes discontinuously. Although the Canny algorithm is used here as the technique for detecting edges, another technique may be used as long as areas where the pixel values of an image change discontinuously can be detected, and an edge detection filter such as a Sobel filter may be used. Performing edge detection on the color buffer with use of the Canny algorithm obtains a binary image divided into edge areas and non-edge areas.

Next, in step S1120 adjacent edges are labeled in the binary image generated in step S1110, and connected components of edges are extracted. This labeling is performed by, for example, assigning the same label if one edge exists in one of eight pixels surrounding a pixel in another edge.

Next, in step S1130 edge elements are extracted from the edges obtained by extracting connected components in step S1120. Here, edge elements are elements constituting three-dimensional edges, and are expressed by three-dimensional coordinates and directions. An edge element is extracted by calculating a division point such that edges assigned the same label are divided at equal intervals in the image, and obtaining very short connected components in the periphery of the division point. In the present embodiment, connected components separated three pixels from the division point are set as end points (initial point and terminal point), and edge elements centered around the division point are extracted. The edge elements extracted from the depth buffer are expressed as EFi (i=1, 2, . . . , N), where N indicates the total number of edge elements. The higher the total number N edge elements, the longer the processing time is. For this reason, the interval between edge elements in the image may be successively modified such that the total number of edge elements is constant.

Next, in step S1140 three-dimensional coordinates in the reference coordinate system are obtained for the edge elements calculated in step S1130. The depth buffer generated in step S1030 is used in this processing. First, the depth values stored in the depth buffer are converted into values in the camera coordinate system. The values stored in the depth buffer are values that have been normalized to values from 0 to 1 according to the clipping range set in the clipping processing performed in step S1030. For this reason, three-dimensional coordinates in the reference coordinate system cannot be directly obtained from the depth values in the depth buffer. In view of this, the values in the depth buffer are converted into values indicating distances from the point of view in the camera coordinate system to the model, with use of the minimum value and maximum value of the clipping range. Next, with use of the internal parameters of the projection matrix, three-dimensional coordinates in the camera coordinate system are obtained based on the two-dimensional coordinates in the image plane of the depth buffer and the depth values in the camera coordinate system. Then, three-dimensional coordinates in the reference coordinate system are obtained by performing, on the three-dimensional coordinates in the camera coordinate system, conversion that is the inverse of the position and orientation conversion used in the rendering of the three dimensional model data in step S1030. Performing the above processing on each edge element EFi obtains three-dimensional coordinates in the reference coordinate system for the edge elements. Also, three-dimensional directions in the reference coordinate system are obtained for the edge elements by calculating three-dimensional coordinates of pixels that are adjacent before and after with respect to the edges obtained in step S1120, and calculating the difference between such three-dimensional coordinates.

When the calculation of the three-dimensional coordinates and directions of the edge elements EFi has ended, the procedure proceeds to step S1050.

In step S1050, the image feature extraction unit 150 detects, from the real image of the current frame imaged by the imaging apparatus 100, edges that correspond to the edge elements EFi (i=1, 2, . . . , N) in the rendered image that were obtained in step S1040. The edge detection is performed by calculating extrema values from a concentration gradient in the captured image, on search lines (line segments in the edge element normal direction) of the edge elements EFi. Edges exist at positions where the concentration gradient is an extrema value on search lines. If only one edge is detected on a search line, that edge is set as a corresponding point, and the image coordinates thereof are held with the three-dimensional coordinates of the edge element EFi. Also, if a plurality of edges are detected on a search line, a plurality of points are held as corresponding candidates. The above processing is repeated for all of the edge elements EFi, and when this processing ends, the processing of S1050 ends, and the procedure proceeds to step S1060.

In step S1060, the feature associating unit 160 determines the most probable corresponding point for an edge element that has a plurality of corresponding points. The most probable corresponding point for, among the edge elements EFi (i=1, 2, . . . , N) in the rendered image that were obtained in step S1040, edge elements EFj (j=1, 2, . . . , M) that have a plurality of corresponding points obtained in step S1050 is obtained by comparing luminance distributions in the edge periphery. Here, M is the number of edge elements having a plurality of corresponding points. FIG. 5 is a flowchart showing a detailed processing procedure of a technique for selecting corresponding edges in the present embodiment.

First, in step S1210 the feature associating unit 160 acquires luminance distributions in the edge peripheries of the edge elements EFj from the rendered image of the three dimensional model data 10 obtained in step S1030. As a luminance distribution in an edge periphery, the luminance values of a predetermined number of pixels in the normal direction of the edge may be acquired, luminance values on a circle separated from the edge position by a predetermined number of pixels may be acquired, or luminance values in a direction parallel to the edge direction that are separated from the edge position by a predetermined number of pixels may be acquired. Also, a luminance distribution may be expressed as a one-dimensional vector of luminance values, a histogram of luminance values, or a gradient histogram. Any type of information may be used as the luminance distribution as long as a degree of similarity between the luminance distributions of the rendered image and the real image can be calculated. In the present embodiment, a one-dimensional vector of luminance values of 21 pixels in the edge normal direction is obtained as a luminance distribution in the edge periphery.

Next, in step S1220, the feature associating unit 160 acquires luminance distributions of the corresponding candidate edges of the edge elements EFj from the real image. The luminance distributions in the edge periphery in the real image are acquired by performing processing similar to that in step S1210 on the corresponding candidate edges for the edge elements EFj obtained in step S1050.

Next, in step S1230, the luminance distributions of the two images obtained in steps S1210 and S1220 are compared, and degrees of similarity between the edge elements EFj and the corresponding candidate edges are calculated. As the degrees of similarity between edges, an SSD (Sum of Square Distance) between luminance distributions may be used, or an NCC (Normalized Cross-Correlation) may be used. Any technique may be used as long as a distance between luminance distributions can be calculated. In the present embodiment, values obtained by normalizing SSDs between luminance distributions by the number of elements are used as the evaluation values.

Next, in step S1240 edges corresponding to the edge elements EFj are selected from among the corresponding candidate edges based on the evaluation values obtained in step S1230. The edges having the highest of the evaluation values obtained in step S1230 (the edges whose appearances are the closest in the image) among the corresponding candidate edges are selected as the corresponding edges. The above processing is repeated for all of the edge elements EFj having a plurality of corresponding points, and when a corresponding point has been obtained for all of the edge elements EFi, the processing of step S1060 ends, and the procedure proceeds to step S1070.

In step S1070, the position and orientation calculation unit 170 calculates the position and orientation of the imaging apparatus 100 by correcting, through an iterative operation, approximate relative positions and orientations of the imaging apparatus 100 and the target object to be observed, with use of nonlinear optimized calculation. Here, let Lc be the total number of edge elements for which corresponding edges have been obtained in step S1060, among the edge elements EFi of the rendered image that were detected in step S1040. Also, let the horizontal direction and the vertical direction of the image be the x axis and the y axis respectively. Furthermore, the projected image coordinates of the center point of an edge element are expressed as (u₀,v₀), and the slope in the image of a straight line of an edge element is expressed as a slope θ with respect to the x axis. The slope θ is calculated as the slope of a straight line connecting the two-dimensional coordinates in the captured image of the end points (initial point and terminal point) of an edge element. The normal line vector in the image of a straight line of an edge element is (sin θ,−cos θ). Also, let the image coordinates of a corresponding point of the edge element be (u′,v′).

Here, the equation of a straight line that passes through the point (u,v) and has the slope θ is expressed as shown in Expression 1 below.

x sin θ−y cos θ=u sin θ−v cos θ (Exp. 1)

The image coordinates in the captured image of an edge element change according to the position and orientation of the imaging apparatus 100. Also, the position and orientation of the imaging apparatus 100 has six degrees of freedom. Here, the parameter expressing the position and orientation of the imaging apparatus is expressed as s. Here, s is a six-dimensional vector composed of three elements expressing the position of the imaging apparatus, and three elements expressing the orientation of the imaging apparatus. The three elements expressing the orientation are, for example, expressed using Euler angles, or expressed using three-dimensional vectors in which a direction expresses a rotation axis and a magnitude expresses a rotation angle. The image coordinates (u,v) of the center point of an edge element can be approximated as shown in Expression 2 below with use of one-dimensional Taylor expansion in the vicinity of (u₀,v₀).

$$u \approx {u}_{0} + {\sum }_{i = 1}^{6} \frac{\partial u}{\partial {s}_{i}} Δ {s}_{i} , \\ v \approx {v}_{0} + {\sum }_{i = 1}^{6} \frac{\partial v}{\partial {s}_{i}} Δ {s}_{i} \qquad ( Exp . 2 )$$

Details of the method for deriving the partial differential ∂u/∂sᵢ,∂v/∂sᵢ of u,v are not mentioned here since this method is widely known, and is disclosed in, for example, “K. Satoh, S. Uchiyama, H. Yamamoto, and H. Tamura, ‘Robust vision-based registration utilizing bird's-eye view with user's view,’ Proc. The 2nd IEEE/ACM International Symposium on Mixed and Augmented Reality (ISMAR03), pp. 46-55, 2003” (hereinafter, called “Document 5”). Substituting Expression 2 into Expression 1 obtains Expression 3 below.

$$x sin θ - y cos θ = ( \begin{matrix}{u}_{0} + \\ {\sum }_{i = 1}^{6} \frac{\partial u}{\partial {s}_{i}} Δ {s}_{i}\end{matrix} ) sin θ - ( \begin{matrix}{v}_{0} + \\ {\sum }_{i = 1}^{6} \frac{\partial v}{\partial {s}_{i}} Δ {s}_{i}\end{matrix} ) cos θ \qquad ( Exp . 3 )$$

Here, a correction value Δs of the position and orientation s of the imaging apparatus is calculated such that a straight line indicated by Expression 3 passes through the image coordinates (u′,v′) of the corresponding point of the edge element. Assuming that r₀=u₀ sin θ−v₀ cos θ (constant) and d=u′ sin θ−v′ cos θ (constant), Expression 4 below is obtained.

$$sin θ {\sum }_{i = 1}^{6} \frac{\partial u}{\partial {s}_{i}} Δ {s}_{i} - cos θ {\sum }_{i = 1}^{6} \frac{\partial v}{\partial {s}_{i}} Δ {s}_{i} = d - {r}_{0} \qquad ( Exp . 4 )$$

Since Expression 4 is true for Lc edge elements, the linear simultaneous equation for Δs as shown in Expression 5 below is true.

$$[ \begin{matrix}\begin{matrix}sin {θ}_{1} \frac{\partial {u}_{1}}{\partial {s}_{1}} - \\ cos {θ}_{1} \frac{\partial {v}_{1}}{\partial {s}_{1}}\end{matrix} & \begin{matrix}sin {θ}_{1} \frac{\partial {u}_{1}}{\partial {s}_{2}} - \\ cos {θ}_{1} \frac{\partial {v}_{1}}{\partial {s}_{2}}\end{matrix} & … & \begin{matrix}sin {θ}_{1} \frac{\partial {u}_{1}}{\partial {s}_{6}} - \\ cos {θ}_{1} \frac{\partial {v}_{1}}{\partial {s}_{6}}\end{matrix} \\ \begin{matrix}sin {θ}_{2} \frac{\partial {u}_{2}}{\partial {s}_{1}} - \\ cos {θ}_{1} \frac{\partial {v}_{2}}{\partial {s}_{1}}\end{matrix} & \begin{matrix}sin {θ}_{2} \frac{\partial {u}_{2}}{\partial {s}_{2}} - \\ cos {θ}_{1} \frac{\partial {v}_{2}}{\partial {s}_{2}}\end{matrix} & … & \begin{matrix}sin {θ}_{2} \frac{\partial {u}_{2}}{\partial {s}_{6}} - \\ cos {θ}_{1} \frac{\partial {v}_{2}}{\partial {s}_{6}}\end{matrix} \\ ⋮ & ⋮ & ⋱ & ⋮ \\ \begin{matrix}sin {θ}_{{L}_{c}} \frac{\partial {u}_{{L}_{c}}}{\partial {s}_{1}} - \\ cos {θ}_{{L}_{c}} \frac{\partial {v}_{{L}_{c}}}{\partial {s}_{1}}\end{matrix} & \begin{matrix}sin {θ}_{2} \frac{\partial {u}_{2}}{\partial {s}_{2}} - \\ cos {θ}_{{L}_{c}} \frac{\partial {v}_{{L}_{c}}}{\partial {s}_{2}}\end{matrix} & … & \begin{matrix}sin {θ}_{{L}_{c}} \frac{\partial {u}_{{L}_{c}}}{\partial {s}_{6}} - \\ cos {θ}_{{L}_{c}} \frac{\partial {v}_{{L}_{c}}}{\partial {s}_{6}}\end{matrix}\end{matrix} ] [ \begin{matrix}Δ {s}_{1} \\ Δ {s}_{2} \\ Δ {s}_{3} \\ Δ {s}_{4} \\ Δ {s}_{5} \\ Δ {s}_{6}\end{matrix} ] = [ \begin{matrix}{d}_{1} - {r}_{1} \\ {d}_{2} - {r}_{2} \\ ⋮ \\ {d}_{{L}_{c}} - {r}_{{L}_{c}}\end{matrix} ] \qquad ( Exp . 5 )$$

Here, Expression 5 is simplified as shown in Expression 6 below.

JΔs=E (Exp. 6)

The correction value Δs is obtained with use of a generalized inverse matrix (J^{T}·J)⁻¹ of matrix J through the Gauss-Newton method or the like based on Expression 6. However, a robust estimation technique such as described below is used since erroneous detections are often obtained in edge detection. Generally, an error d-r increases for an edge element corresponding to an erroneously detected edge. For this reason, the contribution to the simultaneous equations of Expressions 5 and 6 increases, and the accuracy of Δs obtained as a result of such expressions decreases. In view of this, data for edge elements having a high error d-r are given a low weight, and data for edge elements having a low error d-r are given a high weight. The weighting is performed according to, for example, a Tukey function as shown in Expression 7A below.

$$w ( d - r ) = \{ \begin{matrix}{( 1 - {( ( d - r ) / c )}^{2} )}^{2} & \vert d - r \vert \leq c \\ 0 & \vert d - r \vert > c\end{matrix} \qquad ( Exp . 7 A )$$

In Expression 7β, c is a constant. Note that the function for performing weighting does not need to be a Tukey function, and may be a Huber function such as shown in Expression 7B below.

$$w ( d - r ) = \{ \begin{matrix}1 & \vert d - r \vert \leq k \\ k / \vert d - r \vert & \vert d - r \vert > k\end{matrix} \qquad ( Exp . 7 B )$$

Any function may be used as long as a low weight is given to edge elements having a high error d-r, and a high weight is given to edge elements having a low error d-r.

Let wᵢ be the weight corresponding to the edge element EFi. Here, a weighting matrix W is defined as shown in Expression 8 below.

$$W = [ \begin{matrix}{w}_{1} & & & 0 \\ & {w}_{2} & & \\ & & ⋱ & \\ 0 & & & {w}_{{L}_{c}}\end{matrix} ] \qquad ( Exp . 8 )$$

The weighting matrix W is an Lc×Lc square matrix in which all values other than the diagonal components are 0, and the weights wᵢ are the diagonal components. Expression 6 is transformed into Expression 9 below with use of the weighting matrix W.

WJΔs=WE (Exp. 9)

The correction value Δs is obtained through solving Expression 9 as shown in Expression 10 below.

Δs=(J^{T}WJ)⁻¹J^{T}WE (Exp. 10)

The position and orientation of the imaging apparatus 100 is updated with use of the correction value Δs obtained in this way. Next, a determination is made as to whether iterative operations of the position and orientation of the imaging apparatus have converged. A determination is made that calculations of the position and orientation of the imaging apparatus have converged if the correction value Δs is sufficiently small, the sum of errors r-d is sufficiently small, or the sum of errors r-d does not change. If a determination is made that such calculations have not converged, the slope θ of line segments, r₀, d, and partial differential of u,v are re-calculated with use of the updated position and orientation of the imaging apparatus 100, and the correction value Δs is obtained again using Expression 10. Note that the Gauss-Newton method is used in this case as the nonlinear optimization technique. However, another nonlinear optimization technique may be used, such as the Newton-Raphson method, the Levenberg-Marquardt method, a steepest descent method, or a conjugate gradient method. This completes the description of the method for calculating the position and orientation of the imaging apparatus in step S1070.

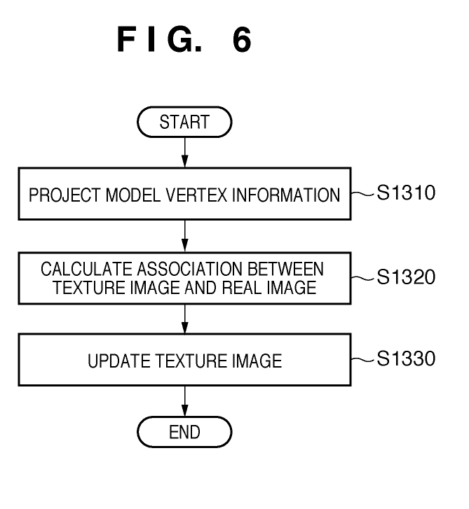

Next is a description of processing for appearance updating in step S1080. Based on the position and orientation information calculated in step S1070, the model updating unit 180 reflects the image information of the target object to be observed that has been acquired from the real image input in step S1020, in the surface information (texture image) of the three dimensional model data 10. FIG. 6 is a flowchart showing a detailed processing procedure of a technique for updating the object appearance in the present embodiment.

First, in step S1310 the model updating unit 180 projects vertex information of the three dimensional model data 10 onto an image plane based on the position and orientation of the target object to be observed that were obtained in step S1070. This processing obtains two-dimensional coordinates in the real image that correspond to the vertex coordinates of the three dimensional model data 10.

Next, in step S1320, the model updating unit 180 calculates a correspondence relationship between the texture image of the three dimensional model data 10 and the real image. In the present embodiment, the two-dimensional coordinates in the texture image that correspond to the vertex image in the three dimensional model data 10 have already been given. In view of this, the correspondence between the real image and the texture image is calculated based on the correspondence information between the three dimensional model data 10 and the texture image, and the correspondence information between the three dimensional model data 10 and the real image that was obtained in step S1310.

Next, in step S1330 the model updating unit 180 maps the luminance information of the real image to the texture image based on the correspondence between the real image and the texture image that was obtained in step S1320, and updates the surface information of the three dimensional model data 10. In the updating, the luminance values in the texture image and the luminance values in the real image are blended according to a constant weight value. This is performed in order to prevent a case in which, if the position and orientation information obtained in step S1070 is inaccurate, luminance values that do not correspond in the first place are reflected in the texture image. Due to the weight value, the luminance values of the real image are reflected slowly over time, thus enabling reducing the influence of a sudden failure in position and orientation estimation. The weight value is set in advance according to a position and orientation estimation precision indicating the frequency with which the position and orientation estimation fails.

Through the above processing, the surface information of the three dimensional model data is updated based on the image information of the target object imaged in the real image. When all of the updating processing has ended, the procedure proceeds to step S1090.

In step S1090, a determination is made as to whether an input for ending the position and orientation calculation has been received, where the procedure is ended if such input has been received, and if such input has not been received, the procedure returns to step S1020, a new image is acquired, and the position and orientation calculation is performed again.

As described above, according to the present embodiment, image information of a target object imaged in a real image is held as surface information of a three dimensional model and updated, thus enabling performing position and orientation estimation based on surface information that conforms with the real image. Accordingly, even if the light source in the real environment changes, image information of a target object can be dynamically reflected in a three dimensional model, and it is possible to perform position and orientation estimation for an object that can robustly deal with a light source change.

<Variation 1-1> Variation on Method of Holding Geometric Information and Surface Information

Although the surface information of the three-dimensional model is expressed as a texture image, and the image information acquired from the real image is held in the texture image in Embodiment 1, there is no limitation to this. The three dimensional model data may be in any format as long as it is a system that enables holding geometric information expressing the shape of the target object, and simultaneously holding surface information corresponding to the geometric information. For example, a system is possible in which a fine mesh model configured from many points and many planes is used, and image information is held as colors at vertices of the points and planes. Also, the geometric information of the three dimensional model may be expressed using a function expression such as an IP model in which plane information is described using an implicit polynomial function, or a metaball in which plane information is described using an n-dimensional function. In such a case, spherical mapping of the texture image or the like may be used in order to express surface information so as to correspond to the geometric information.

<Variation 1-2> Use of Point Features

Although edges are used as features extracted from the rendered image and the real image in Embodiment 1, there is no limitation to this. It is possible to use point features detected by, for example, a Harris detector, or a SIFT detector disclosed in “I. Skrypnyk and D. G. Lowe, ‘Scene modelling, recognition and tracking with invariant image features,’ Proc. The 3rd IEEE/ACM International Symposium on Mixed and Augmented Reality (ISMAR04), pp. 110-119, 2004” (hereinafter, called “Document 6”). In this case, as a point feature descriptor, a luminance distribution in the point feature periphery may be used, or a SIFT description disclosed in Document 6 may be used, and there is no particular limitation on the selection of the point feature detector or descriptor. Even if point features are used in the association of a rendered image and a real image, position and orientation estimation can be performed by associating point features detected in the rendered image and point features detected in the real image, using a processing flow that is not largely different from that in Embodiment 1.

### Embodiment 2

### Position and Orientation Estimation Based on Change in Brightness Between Images

In Embodiment 1, features are extracted from a rendered image and a real image, the extracted features are associated with each other, and the position and orientation of an object are calculated by performing a nonlinear optimized calculation based on the associations. In Embodiment 2, an example is described in which the present invention is applied to a technique in which it is assumed that the brightness of a point on the surface of an object does not change even after the position and orientation of an imaging apparatus has changed, and the position and orientation of the object is obtained directly from a change in brightness.

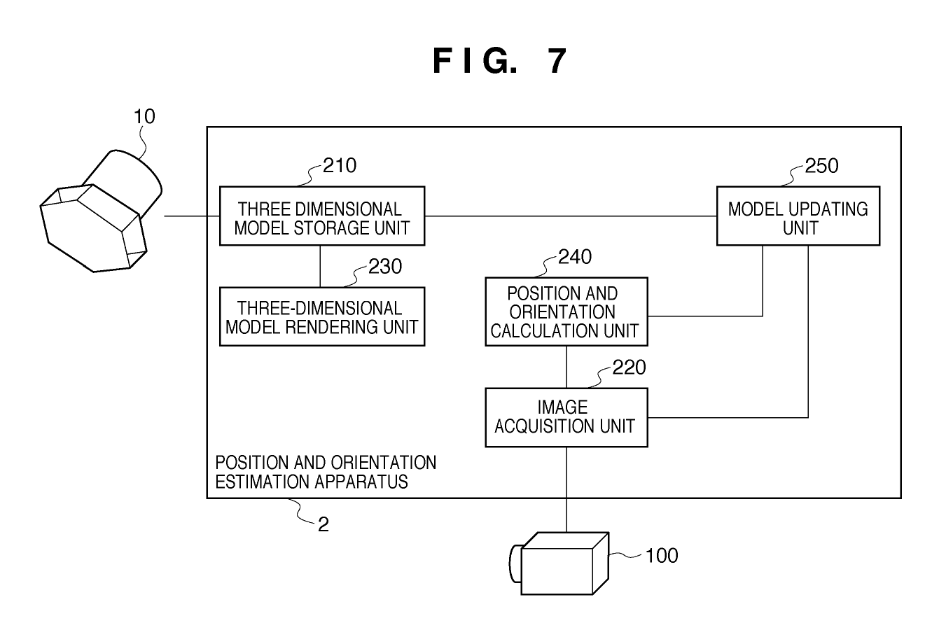

FIG. 7 is a diagram showing a configuration of a position and orientation estimation apparatus 2 according to the present embodiment. As shown in FIG. 7, the position and orientation estimation apparatus 2 is equipped with a three-dimensional model storage unit 210, an image acquisition unit 220, a three-dimensional model rendering unit 230, a position and orientation calculation unit 240, and a model updating unit 250. Three dimensional model data 10 is stored in the three-dimensional model storage unit 210. The three-dimensional model storage unit 210 is also connected to the model updating unit 250. The imaging apparatus 100 is connected to the image acquisition unit 220. The position and orientation estimation apparatus 2 measures the position and orientation of a target object to be observed that is imaged in a real image, based on the three dimensional model data 10 that is stored in the three-dimensional model storage unit 210 and expresses the shape of the target object to be observed. Note that in the present embodiment, there is the assumption that the applicability of the position and orientation estimation apparatus 2 is conditional upon the fact that the three dimensional model data 10 stored in the three-dimensional model storage unit conforms with the shape of the target object to be observed that is actually imaged.

Next is a description of the units configuring the position and orientation estimation apparatus 2. The three-dimensional model rendering unit 230 renders the three dimensional model data 10 stored in the three-dimensional model storage unit 210. The processing performed by the three-dimensional model rendering unit 230 is basically the same as the processing performed by the three-dimensional model rendering unit 130 in Embodiment 1. However, this processing differs from Embodiment 1 in that model rendering processing is performed a plurality of times in order to be used by the position and orientation calculation unit 240.

The position and orientation calculation unit 240 directly calculates a position and orientation based on a gradient method with use of a change in brightness between the rendered image that has been rendered by the three-dimensional model rendering unit 230 and the real image that has been acquired by the image acquisition unit 220. A method for position and orientation estimation based on a gradient method is described later.

A description of the three-dimensional model storage unit 210, the image acquisition unit 220, and the model updating unit 250 has been omitted since they have functions similar to those of the three-dimensional model storage unit 110, the image acquisition unit 120, and the model updating unit 180 in Embodiment 1.

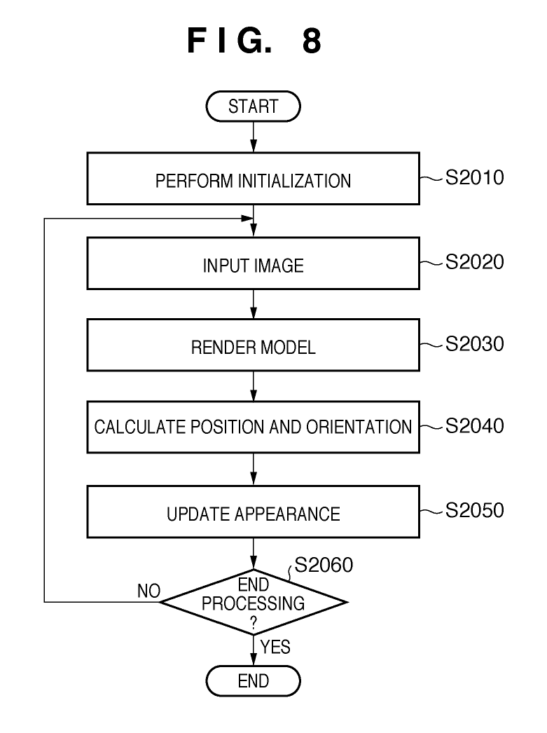

Next is a description of a processing procedure of the position and orientation estimation method according to the present embodiment. FIG. 8 is a flowchart showing the processing procedure of the position and orientation estimation method according to the present embodiment.

Initialization is performed in step S2010. The processing content of step S2010 is basically the same as that of step S1010 in Embodiment 1, and therefore a description of redundant portions has been omitted.

In step S2020, an image is input. A description of this processing has been omitted since it is the same as the processing in step S1020 in Embodiment 1.

Next, in step S2030, the three-dimensional model rendering unit 230 obtains a rendered image for comparison with a real image, by rendering the three dimensional model data stored in the three-dimensional model storage unit 210 based on the approximate position and orientation of the target object to be observed that were obtained in step S2010. The processing content of step S2030 is basically the same as that of step S1030 in Embodiment 1, and therefore a description of redundant portions has been omitted. Step S2030 differs from step S1030 in the following way. Specifically, in order to perform position and orientation estimation in the subsequent step S2040, in addition to the CG rendering performed based on the approximate position and orientation of the target object to be observed that were obtained in step S2010, CG rendering is performed based on approximate positions and orientations that are slightly changed from the aforementioned approximate position and orientation, which has six degrees of freedom, in positive and negative directions of each of the degrees of freedom. The rendered images obtained using such slightly changed approximate positions and orientations are used in position and orientation estimation processing that is described later. In the present processing, one rendered image is generated based on an approximate position and orientation, and 12 rendered images are generated based on slightly changed approximate positions and orientations.

In step S2040, the position and orientation of the object to be observed are calculated using a gradient method. Specifically, by formulating the relationship between a temporal change in brightness in a real image and a change in brightness that occurs due to a change in the position and orientation of an object in a rendered image, the position and orientation of the object can be directly calculated from the change in brightness. Here, assuming that the surrounding environment (for example, the light source environment) does not change, if a parameter expressing the position and orientation of an object in a three-dimensional space is determined, the appearance is uniquely determined in a two-dimensional image. Here, the parameter expressing the position and orientation of the imaging apparatus is expressed as s. Here, s is a six-dimensional vector composed of three elements expressing the position of the imaging apparatus, and three elements expressing the orientation of the imaging apparatus. The three elements expressing the orientation are, for example, expressed using Euler angles, or expressed using three-dimensional vectors in which a direction expresses a rotation axis and a magnitude expresses a rotation angle. Let I(s) be the brightness of a point on the surface of the object at a time t. Assuming that the position and orientation of the object changes by δs after a very short time δt, and that the brightness of the same point on the surface of the object in the image does not change, the brightness I can be expressed using Taylor expansion as shown in Expression 11 below.

$$I ( s + Δ s ) = I ( s ) + {\sum }_{i = 1}^{6} \frac{\partial I}{\partial {s}_{i}} Δ {s}_{i} + ɛ \qquad ( Exp . 11 )$$

Here, ε is a second-order or higher high-order expression, but if this is ignored, approximation to a first-order expression is performed, and ΔI is assumed to be a change in brightness that occurs due to object motion between image frames, the following expression is approximately true based on Expression 11.

$$Δ I = I ( s + Δ s ) - I ( s ) \approx {\sum }_{i = 1}^{6} \frac{\partial I}{\partial {s}_{i}} Δ {s}_{i} \qquad ( Exp . 12 )$$

Applying this constraint equation to all pixels in an image obtains Δs. Here, obtaining Δs requires numerically obtaining the partial differential coefficient ∂I/∂pi of the right-hand side of Expression 12. In view of this, the partial differential coefficient ∂I/∂pi is approximated to the following expression with use of a very small finite value δ.

$$\frac{\partial {I}^{⋒}}{\partial {s}_{i}} ≅ \frac{{I}^{⋒} ( \begin{matrix}{s}_{1} , … {s}_{i} + \\ \frac{1}{2} δ , … , {s}_{6}\end{matrix} ) - {I}^{⋒} ( \begin{matrix}{s}_{1} , … {s}_{i} - \\ \frac{1}{2} δ , … , {s}_{6}\end{matrix} )}{\partial {s}_{i}} \qquad ( Exp . 13 )$$

I expresses a pixel vale in a rendered image obtained by performing CG rendering on three dimensional model data using the position and orientation parameter s. The partial differential coefficient ∂I/∂pi can be approximately obtained by obtaining differences between rendered images generated by slightly changing the elements of the position and orientation parameter s. The 12 rendered images generated in step S2030 are used here.

Here, letting the image space be defined as an N-dimensional space, one image having N pixels is expressed as an image vector whose elements are N luminance values. Since Expression 13 is true for an image having N luminance values as elements, the linear simultaneous equation for Δs as shown in Expression 14 below is true.

$$[ \begin{matrix}\frac{{{I}^{⋒}}_{1}}{\partial {s}_{1}} & \frac{{{I}^{⋒}}_{1}}{\partial {s}_{2}} & … & \frac{{{I}^{⋒}}_{1}}{\partial {s}_{6}} \\ \frac{{{I}^{⋒}}_{2}}{\partial {s}_{1}} & \frac{{{I}^{⋒}}_{2}}{\partial {s}_{2}} & … & \frac{{{I}^{⋒}}_{2}}{\partial {s}_{6}} \\ ⋮ & ⋮ & ⋱ & ⋮ \\ \frac{{{I}^{⋒}}_{N}}{\partial {s}_{1}} & \frac{{{I}^{⋒}}_{N}}{\partial {s}_{2}} & … & \frac{{{I}^{⋒}}_{N}}{\partial {s}_{6}}\end{matrix} ] [ \begin{matrix}Δ {s}_{1} \\ Δ {s}_{2} \\ Δ {s}_{3} \\ Δ {s}_{4} \\ Δ {s}_{5} \\ Δ {s}_{5}\end{matrix} ] = [ \begin{matrix}{I}_{1} - {{I}^{⋒}}_{1} ( s ) \\ {I}_{2} - {{I}^{⋒}}_{2} ( s ) \\ ⋮ \\ {I}_{N} - {{I}^{⋒}}_{N} ( s )\end{matrix} ] \qquad ( Exp . 14 )$$

Here, Expression 14 is simplified as shown in Expression 15 below.

JΔs=E (Exp. 15)

Generally, the number of pixels N is much larger than six, which is the number of degrees of freedom of the position and orientation parameter. For this reason, similarly to step S1080 in Embodiment 1, Δs is obtained with use of a generalized inverse matrix (J^{T}·J)⁻¹ of matrix J through the Gauss-Newton method or the like based on Expression 15. This completes the description of the method for calculating the position and orientation of the imaging apparatus 100 in step S2040.

Next, in step S2050, the model updating unit 250 performs appearance updating processing. Specifically, based on the position and orientation information calculated in step S2040, the model updating unit 250 reflects the image information of the target object to be observed that has been acquired from the real image input in step S2020, in the surface information (texture image) of the three dimensional model data 10. The processing content of step S2050 is basically the same as that of step S1080 in Embodiment 1, and therefore a description of redundant portions has been omitted.

In step S2060, a determination is made as to whether an input for ending the position and orientation calculation has been received, where the procedure is ended if such input has been received, and if such input has not been received, the procedure returns to step S2020, a new image is acquired, and the position and orientation calculation is performed again.

As described above, according to the present embodiment, image information of a target object imaged in a real image is held as surface information of a three dimensional model and updated, thus enabling performing position and orientation estimation based on surface information that conforms with the real image. Accordingly, even if the light source in the real environment changes, image information of a target object can be dynamically reflected in a three dimensional model, and it is possible to perform position and orientation estimation for an object that can robustly deal with a light source change.

<Variation 2-1> Optimization of Evaluation Value Calculated from Overall Image

Although a gradient method is used in the position and orientation calculation for aligning a rendered image and a real image in Embodiment 2, there is no limitation to this. For example, a configuration is possible in which an evaluation value is calculated from a comparison between a rendered image and a real image, and a position and orientation are calculated such that the evaluation value is optimized. In this case, as the evaluation calculation method, an SSD between a rendered image and a real image may be used, a normalized cross-correlation between a rendered image and a real image may be used, or a method of obtaining a degree of similarity with use of some kind of mutual information amount may be used. Any method may be used to calculate an evaluation value as long as a value that indicates the similarity between a rendered image and a real image can be calculated. Also, the evaluation value optimization method may be any method of calculating a position and orientation by optimization of an evaluation value, such as a greedy algorithm, a hill-climbing method, or a simplex method.

As described above, according to the above-described embodiments, surface information of three dimensional model data to be used in position and orientation estimation is updated with use of image information of a target object to be observed that is imaged in a real image. For this reason, a stable position and orientation can be realized even if a change in the light source occurs in the real environment, or a change in appearance occurs due to a change in the orientation of the target object.

As described above, according to the embodiments, surface information of a three dimensional model is updated based on image information of a target object imaged in a real image, thus enabling providing position and orientation estimation based on surface information of a three dimensional model that can robustly deal with a change in the light source and a large change in the position and orientation of a target object.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-120391, filed May 18, 2009, which is hereby incorporated by reference herein in its entirety.

What is claimed is:

1. A position and orientation estimation apparatus comprising:
an acquisition unit configured to acquire a real image obtained by an imaging apparatus by imaging a target object to be observed;
a holding unit configured to hold three dimensional model data expressing a shape and surface information of the target object;
a rendering unit configured to generate a rendered image by projecting a three dimensional model onto an image plane based on the three dimensional model data and position and orientation information of the imaging apparatus;
a calculation unit configured to detect correspondence between the rendered image generated by the rendering unit and an image of the target object in the real image, and calculate a relative position and orientation of the imaging apparatus and the target object based on the correspondence; and
an updating unit configured to update the surface information of the three dimensional model data held in the holding unit by, based on the positions and orientations calculated by the calculation unit, associating the image of the target object in the real image with the surface information of the three dimensional model data.

2. The position and orientation estimation apparatus according to claim 1,
wherein the calculation unit calculates the positions and orientations based on a difference between the rendered image and the image of the target object in the real image.

3. The position and orientation estimation apparatus according to claim 1,
wherein the calculation unit includes
a model feature extraction unit configured to extract a feature from the rendered image based on a luminance or a color in the three dimensional model data, and
an image feature extraction unit configured to extract a feature from the real image based on a luminance or a color of the target object, and
the calculation unit calculates a relative position and orientation of the imaging apparatus with respect to the target object to be observed, based on a correspondence between the feature extracted by the model feature extraction unit and the feature extracted by the image feature extraction unit.

4. The position and orientation estimation apparatus according to claim 3,
wherein the model feature extraction unit and the image feature extraction unit extract an edge feature.

5. The position and orientation estimation apparatus according to claim 3,
wherein the model feature extraction unit and the image feature extraction unit extract a point feature.

6. The position and orientation estimation apparatus according to claim 1,
wherein the updating unit updates a texture image corresponding to the three dimensional model data with use of the image of the target object.

7. A position and orientation estimation method comprising:
acquiring a real image obtained by an imaging apparatus by imaging a target object to be observed;
generating a rendered image by projecting a three dimensional model onto an image plane based on three dimensional model data that is held in a holding unit and expresses a shape and surface information of the target object, and position and orientation information of the imaging apparatus;
detecting correspondence between the rendered image generated in the rendering step and an image of the target object in the real image, and calculating a relative position and orientation of the imaging apparatus and the target object to be observed based on the correspondence; and
updating the surface information of the three dimensional model data held in the holding unit by, based on the positions and orientations calculated in the calculating step, associating image information of the target object to be observed in the real image with the surface information of the three dimensional model data.

8. A computer readable storage medium storing a computer program for causing a computer to execute the position and orientation estimation method according to claim 7.
